(19) United States
(12) Patent Application Publication
(10) Pub. No.: US 2025/0055726 A1
(43) Pub. Date: Feb. 13, 2025

(54) ON-BOARD DEVICE, CONNECTION SWITCHING METHOD, AND CONNECTION SWITCHING PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Shota USHIRO, Yokkaichi-shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/716,756

(22) PCT Filed: Nov. 22, 2022
(86) PCT No.: PCT/JP2022/043192

§ 371 Date: Jun. 5, 2024

(30) Foreign Application Priority Data
Dec. 9, 2021 (JP) 2021-199722

(51) Int. Cl. H04L 12/40

(52) U.S. Cl. CPC H04L 12/40039; H04L 2012/40215

(57) ABSTRACT

An on-board device mounted in a vehicle includes: a processor; a communication port; a first communication integrated circuit that is connected to the processor and that is configured to output a frame, which has been received via the communication port from outside the on-board device, to the processor; a second communication integrated circuit that is connected to the processor and is operable when a frame received via the communication port satisfies a predetermined condition, to output the received frame to the processor; and a first switching unit for switching the communication port between being connected to the first communication integrated circuit and being connected to the second communication integrated circuit.

### CROSS-REFERENCE TO RELATED APPLICATIONS

This application is the U.S. national stage of PCT/JP2022/043192 filed on Nov. 22, 2022, which claims priority of Japanese Patent Application No. JP 2021-199722 filed on Dec. 9, 2021, the contents of which are incorporated herein.

### TECHNICAL FIELD

The present disclosure relates to an on-board, a connection switching method, and a connection switching program.

### BACKGROUND

JP 2015-081021A discloses a vehicle-mounted network system described below. This vehicle-mounted network system includes a plurality of ECUs, which are provided with a function of selectively executing a normal mode and a sleep mode based on network management that is compatible with partial networking, and a management ECU. The power of each ECU can be individually turned on and off by a power relay of the management ECU. The management ECU identifies a scene corresponding to the state of the vehicle based on information that has been acquired via a communication bus, and determines a control content for switching the power of specified ECUs on and off corresponding to the identified scene. Based on the determined control content, the switches of the power relay are operated to turn the power of the specified ECUs on and off.

In the past, as the functions of on-board devices installed in vehicles have become more sophisticated, the processing load and communication load placed on such on-board devices have tended to increase. Various techniques for suppressing power consumption in such on-board devices have been developed.

There is demand for a technology that suppresses the power consumption in an on-board device further than the technology disclosed in JP 2015-081021A cited above and has higher reliability.

### SUMMARY

The present disclosure was conceived to solve the problem described above and has an object of providing an on-board device, a connection switching method, and a connection switching program that suppress the power consumption in an on-board device and have higher reliability.

### Advantageous Effects

According to the present disclosure, it is possible to suppress power consumption in an on-board device and achieve higher reliability.

An on-board according to the present disclosure is an on-board device mounted in a vehicle and includes: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit.

A connection switching method according to the present disclosure is a connection switching method of an on-board device mounted in a vehicle, wherein the on-board device includes: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit, the connection switching method including: a step of controlling the first switching unit to electrically connect the communication port and the second communication integrated circuit; and a step of controlling the first switching unit to electrically connect, when a state of the on-board device satisfies a predetermined condition, the communication port and the first communication integrated circuit.

A connection switching program according to the present disclosure is a connection switching program used in an on-board device mounted in a vehicle, wherein the on-board device includes: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit, the connection switching program causing a computer to function as a control unit configured to control the first switching unit to electrically connect the communication port and the second communication integrated circuit and controls the first switching unit to electrically connect, when a state of the on-board device satisfies a predetermined condition, the communication port and the first communication integrated circuit.

One aspect of the present disclosure may be realized as a semiconductor integrated circuit that realizes part or all of the on-board device described above or may be realized as a system including the on-board device.

### BRIEF DESCRIPTION OF DRAWINGS

FIG. 1 depicts the configuration of an on-board device according to an embodiment of the present disclosure.

FIG. 2 is a diagram useful in explaining a switching operation of a first switching unit of an on-board device according to an embodiment of the present disclosure.

FIG. 3 is a diagram useful in explaining a switching operation of a second switching unit of an on-board device according to an embodiment of the present disclosure.

FIG. 4 is a diagram useful in explaining the operation of a processor when the on-board device according to an embodiment of the present disclosure is in a PN transceiver connection state.

FIG. 5 is a diagram useful in explaining the operation of a processor when the on-board device according to an embodiment of the present disclosure is in a normal transceiver connection state.

FIG. 6 is a flowchart that defines one example operation procedure for switching the connection state of an on-board device according to the embodiment of the present disclosure.

FIG. 7 is a flowchart defining an example operation procedure of a loopback test of an on-board device according to an embodiment of the present disclosure.

FIG. 8 depicts the configuration of an on-board device according to a modification to the embodiments of the present disclosure.

FIG. 9 is a timing chart indicating, for a case where an on-board device according to a modification to the embodiments of the present disclosure is in a normal transceiver connection state, the relationship between the timing at which an on-board device receives each frame and the timing at which a processor in the on-board device wakes up.

FIG. 10 is a timing chart indicating, for a case where the on-board device according to this modification to the embodiments of the present disclosure is in a PN transceiver connection state, the relationship between the timing at which the on-board device receives each frame and the timing at which the processor in the on-board device wakes up.

### DETAILED DESCRIPTION OF PREFERRED EMBODIMENTS

Several embodiments of the present disclosure will first be listed and described in outline.

An on-board device according to an embodiment of the present disclosure is an on-board device mounted in a vehicle, including: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit.

With the above configuration, as one example, the communication port and the second communication integrated circuit are electrically connected during normal operation and the processor wakes up when a frame that satisfies a predetermined condition arrives at the processor, which suppresses power consumption. As a further example, by electrically connecting the communication port and the first communication integrated circuit when a problem has occurred at the second communication integrated circuit or the like, it is possible to have frames transmitted to the on-board device processed by the processor. Accordingly, power consumption in the on-board device can be suppressed and reliability can be improved.

The above on-board device may further include a second switching unit that is connected between the first communication integrated circuit and the first switching unit, wherein the second switching unit may switch between a state where the first communication integrated circuit and the first switching unit are electrically connected and a state where the first communication integrated circuit and the second communication integrated circuit are electrically connected.

With the above configuration, as one example, it is possible to perform a loopback test where frames are transmitted and received between the first communication integrated circuit and the second communication integrated circuit, and to detect any problems with the second communication integrated circuit, software of the processor that processes frames from the second communication integrated circuit, or the like.

In a state where the first switching unit electrically connects the second switching unit and the communication port and the second switching unit electrically connects the first communication integrated circuit and the second communication integrated circuit, the processor may perform a loopback test for transmitting and receiving a frame between the first communication integrated circuit and the second communication integrated circuit.

With the above configuration, since it is possible to perform a loopback test in a state that prevents frames from outside the on-board device from reaching the processor, more accurate test results can be obtained.

The first communication integrated circuit may be a CAN (Controller Area Network) transceiver, and the second communication integrated circuit may be a CAN receiver, which is compatible with partial networking.

With the above configuration, it is possible to suppress the power consumption and improve reliability of an on-board device that performs communication according to CAN.

The processor may perform the loopback test in a state where the vehicle is stopped.

With the above configuration, it is possible to prevent the loopback test from affecting the running of the vehicle.

The state where the vehicle is stopped may be a state where the vehicle is parked.

In this way, by performing the loopback test while the vehicle is stopped for an extended time, it is possible to more reliably prevent the loopback test from affecting the running of the vehicle.

In the loopback test, the processor may perform a first test, which checks whether reception of a frame which was outputted to the first communication integrated circuit is possible from the second communication integrated circuit, and a second test, which checks whether reception of a frame outputted to the second communication integrated circuit is possible from the first communication integrated circuit, and may notify an external apparatus provided outside the vehicle of a result of the first test and a result of the second test.

In this way, with the configuration in which both the first test and the second test are performed, it is possible to more accurately detect problems with the second communication integrated circuit, the software of the processor that processes frames from the second communication integrated circuit, and the like. With a configuration where an external apparatus outside the vehicle is notified of the test results, it is possible for a vehicle management center for example to grasp a problem at the second communication integrated circuit or the like in the vehicle.

When the processor has received an instruction based on the result of the first test and the result of the second test from the external apparatus after notifying the external apparatus of the result of the first test and the result of the second test, the processor may control the first switching unit to switch the communication port between being connected to the first communication integrated circuit and being connected to the second communication integrated circuit in accordance with the instruction.

With the above configuration, as one example, it is possible, for a management center capable of grasping various information, to more appropriately determine what the communication port in an on-board device should be connected to.

The processor may be capable of performing a sleep operation, and the processor may switch modes relating to the sleep operation in a first connection state where the first switching unit electrically connects the first communication integrated circuit and the communication port and in a second connection state where the first switching unit electrically connects the second communication integrated circuit and the communication port.

When the on-board device is in the second connection state, there is a high probability that frames will arrive at the processor less frequently than when the on-board device is in the first connection state. With the above configuration, since the processor can be operated in an appropriate mode in keeping with the frequency of frames arriving at the processor, it is possible to appropriately suppress the power consumption of the on-board device.

In the first connection state, the processor may operate in a mode where the processor intermittently wakes up, and in the second connection state, the processor may operate in a mode where the processor wakes up when a frame from outside the on-board device has been received from the second communication integrated circuit.

With the above configuration, it is possible to appropriately suppress power consumption in the on-board device while enabling the processor to process frames that arrive at the processor.

The processor may operate in a mode where the processor wakes up intermittently, and a cycle at which the processor wakes up in the second connection state may be longer than a cycle at which the processor wakes up in the first connection state.

In this way, with a configuration where the processor wakes up intermittently regardless of whether the connection state of the on-board device is either of the first connection state and the second connection state, the processor will be capable of processing frames even when the frames have been received without passing either the first communication integrated circuit or the second communication integrated circuit. By using a configuration where the cycle of waking up the processor in the second connection state is longer than the cycle of waking up the processor in the first connection state, it is possible to appropriately suppress power consumption by the on-board device in keeping with the frequency of frames arriving at the processor.

A connection switching method according to an embodiment of the present disclosure is a connection switching method of an on-board device mounted in a vehicle, wherein the on-board device includes: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit, the connection switching method including: a step of controlling the first switching unit to electrically connect the communication port and the second communication integrated circuit; and a step of controlling the first switching unit to electrically connect, when a state of the on-board device satisfies a predetermined condition, the communication port and the first communication integrated circuit.

With the above method, as one example, the communication port and the second communication integrated circuit are electrically connected during normal operation and the processor wakes up when a frame that satisfies a predetermined condition arrives at the processor, which suppresses power consumption. As a further example, by electrically connecting the communication port and the first communication integrated circuit when a problem has occurred at the second communication integrated circuit or the like, it is possible to have frames transmitted to the on-board device processed by the processor. Accordingly, power consumption in the on-board device can be suppressed and reliability can be improved.

A connection switching program according to an embodiment of the present disclosure is a connection switching program for use in an on-board device mounted in a vehicle, wherein the on-board device includes: a processor; a communication port; a first communication integrated circuit that is connected to the processor and that is configured to output a frame, which has been received via the communication port from outside the on-board device, to the processor; a second communication integrated circuit that is connected to the processor and is configured to, when a frame received via the communication port satisfies a predetermined condition, output the received frame to the processor; and a first switching unit configured to switch the communication port between being connected to the first communication integrated circuit and being connected to the second communication integrated circuit, the connection switching program causing a computer to function as a control unit configured to control the first switching unit to electrically connect the communication port and the second communication integrated circuit and controls the first switching unit to electrically connect, when a state of the on-board device satisfies a predetermined condition, the communication port and the first communication integrated circuit.

With the above configuration, as one example, the communication port and the second communication integrated circuit are electrically connected during normal operation and the processor wakes up when a frame that satisfies a predetermined condition arrives at the processor, which suppresses power consumption. As a further example, by electrically connecting the communication port and the first communication integrated circuit when a problem has occurred at the second communication integrated circuit or the like, it is possible to have frames transmitted to the on-board device processed by the processor. Accordingly, power consumption in the on-board device can be suppressed and reliability can be improved.

Preferred embodiments of the present disclosure will now be described with reference to the drawings. Note that identical and corresponding parts in the drawings have been assigned the same reference numerals, and description thereof will not be repeated. The embodiments described below may also be freely combined, at least in part.

### Configuration and Basic Operation

### Overall Configuration

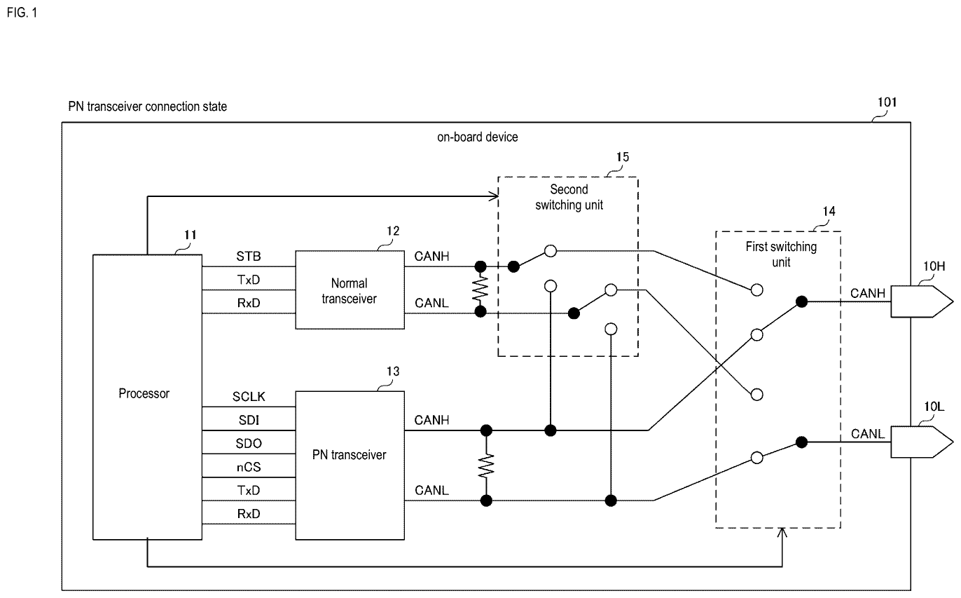

FIG. 1 depicts the configuration of an on-board device according to an embodiment of the present disclosure. As depicted in FIG. 1, one example of an on-board device 101 is an ECU (Electronic Control Unit) mounted in a vehicle.

As a detailed example, the vehicle is equipped with a communication system including a plurality of ECUs and an integrated ECU that controls the plurality of ECUs. As one example, the on-board device 101 is one of the ECUs that is controlled by this integrated ECU, and communicates with other ECUs or the integrated ECU in this communication system in accordance with CAN (Controller Area Network) standard.

In more detail, the on-board device 101 includes communication ports 10H and 10L that respectively correspond to CANH and CANL communication lines, a processor 11 such as a CPU (Central Processing Unit), a DSP (Digital Signal Processor), an FPGA (Field Programmable Gate Array) or an ASIC (Application Specific Integrated Circuit), a normal transceiver 12, which is one example of a “first communication integrated circuit” for the present disclosure, a PN transceiver 13, which is an example of a “second communication integrated circuit” for the present disclosure, a first switching unit 14, and a second switching unit 15. As examples, the communication ports 10H and 10L are connectors or terminals of an integrated circuit. The processor 11 is one example of a “control unit” for the present disclosure.

As one example, the normal transceiver 12 is a CAN transceiver and is connected to the processor 11 via three terminals corresponding to STB (Strobe), TxD (Transmit Data), and RxD (Receive Data), respectively.

On receiving a frame transmitted from outside the on-board device 101 via the communication ports 10H and 10L, the normal transceiver 12 outputs the frame to the processor 11. Also, on receiving a frame outputted from the processor 11, the normal transceiver 12 transmits the frame via the communication ports 10H and 10L to outside the on-board device 101.

As one example, the PN transceiver 13 is a CAN transceiver compatible with partial networking. The PN transceiver 13 is connected to the processor 11 via six terminals corresponding to SCLK (Serial CLocK), SDI (Serial Data In), SDO (Serial Data Out), nCS (nChip Select), TxD, and RxD.

When the PN transceiver 13 has received a frame transmitted from outside the on-board device 101 via the communication ports 10H and 10L, the PN transceiver 13 determines whether the frame satisfies a predetermined condition. On determining that the frame satisfies a predetermined condition, the PN transceiver 13 outputs the frame to the processor 11.

On receiving a frame outputted from the processor 11, the PN transceiver 13 transmits the frame via the communication ports 10H and 10L to outside the on-board device 101.

The first switching unit 14 operates on receiving a control signal from the processor 11 and is capable of switching the communication ports 10H and 10L from being connected to the normal transceiver 12 and being connected to the PN transceiver 13.

The second switching unit 15 is connected between the normal transceiver 12 and the first switching unit 14. The second switching unit 15 operates on receiving a control signal from the processor 11 and switches between a state where the normal transceiver 12 and the first switching unit 14 are electrically connected and a state where the normal transceiver 12 and the PN transceiver 13 are electrically connected.

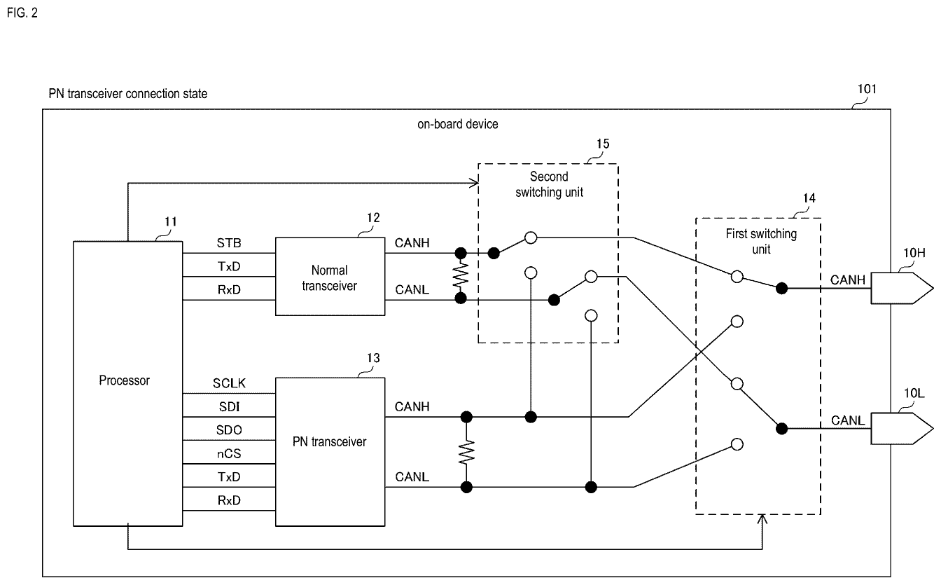

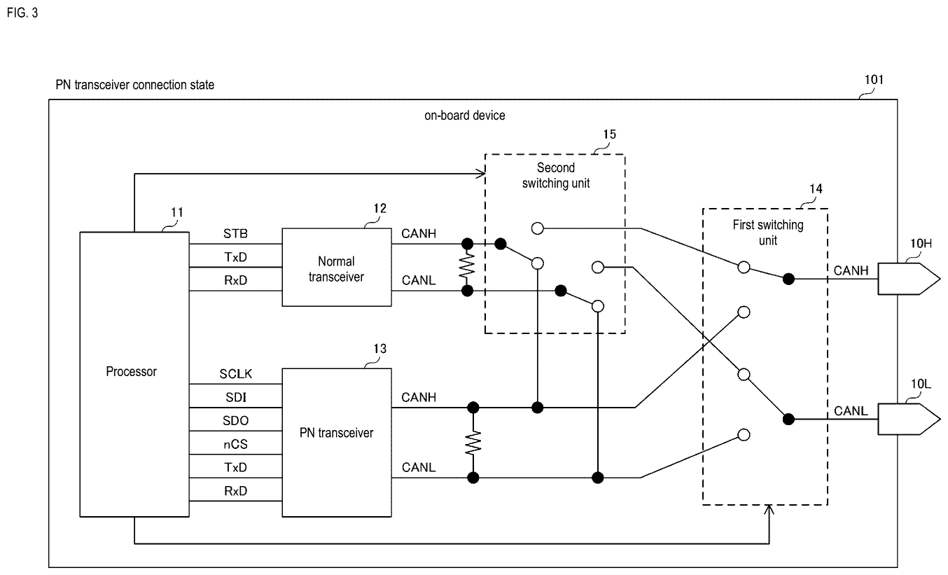

FIG. 2 is a diagram useful in explaining a switching operation of the first switching unit in an on-board device according to an embodiment of the present disclosure. FIG. 3 is a diagram useful in explaining a switching operation of the second switching unit in the on-board device according to an embodiment of the present disclosure.

Out of FIGS. 1 to 3, FIG. 1 depicts a state where the first switching unit 14 electrically connects the communication ports 10H and 10L to the PN transceiver 13, and the second switching unit 15 electrically connects the normal transceiver 12 and the first switching unit 14 (this state is hereinafter referred to as the “PN transceiver connection state” (or a “second connection state” for the present disclosure).

FIG. 2 depicts a state where the second switching unit 15 electrically connects the normal transceiver 12 and the first switching unit 14, and the first switching unit 14 electrically connects the normal transceiver 12 via the second switching unit 15 to the communication ports 10H and 10L (this state is hereinafter referred to as the “normal transceiver connection state” (or “first connection state” for the present disclosure).

FIG. 3 depicts a state where the first switching unit 14 electrically connects the communication ports 10H and 10L to the second switching unit 15 and the second switching unit 15 electrically connects the normal transceiver 12 and the PN transceiver 13 (this state is hereinafter referred to as the “loopback connection state”).

Note that the on-board device 101 is not limited to a configuration that performs communication according to CAN, and may for example be configured to perform communication according to LIN (Local Interconnect Network) or CXIP (Clock Extension Peripheral Interface). In such case, the on-board device 101 includes communication port corresponding to LIN or CXIP communication lines in place of the communication ports 10H and 10L that respectively correspond to CANH and CANL communication lines.

### Details of PN Transceiver Connection State

As depicted in FIG. 1, the processor 11 controls the first switching unit 14 and the second switching unit 15 so that the on-board device 101 enters the PN transceiver connection state at the start of operation, for example.

In this PN transceiver connection state, a frame transmitted to the on-board device 101 from outside the on-board device 101 arrives at the PN transceiver 13 via the communication ports 10H and 10L. On receiving the frame, as one example the PN transceiver 13 refers to an ID (Identification) or the like included in the frame and determines whether the frame satisfies a predetermined condition.

As a detailed example, the PN transceiver 13 checks whether a bit pattern of the ID included in the frame matches a predetermined pattern registered in advance in the PN transceiver 13. If the bit pattern matches a predetermined pattern, the PN transceiver 13 determines that the frame satisfies the predetermined condition and outputs the frame to the processor 11.

On the other hand, if the bit pattern of the ID included in the frame does not match a predetermined pattern, the PN transceiver 13 determines that the frame does not satisfy the predetermined condition and discards the frame, for example.

Note that in addition to the bit pattern of the ID included in a frame from outside the on-board device 101, the PN transceiver 13 may also check a data length of the frame and determine whether the frame satisfies a predetermined condition based on a combination of the bit pattern of the ID and the data length.

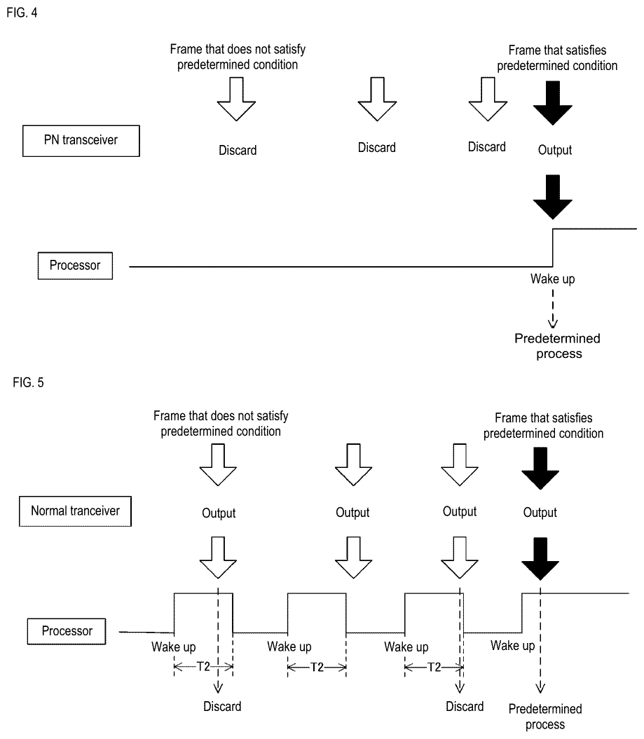

FIG. 4 is a diagram useful in explaining the operation of the processor when the on-board device according to an embodiment of the present disclosure is in the PN transceiver connection state. As depicted in FIG. 4, the processor 11 is capable of performing a sleep operation, and switches modes relating to the sleep operation between the PN transceiver connection state and the normal transceiver connection state.

In more detail, when the on-board device 101 is in the PN transceiver connection state, the processor 11 operates in a mode (hereinafter referred to as “PN sleep mode”) where the processor 11 is continuously in a sleep state when a frame has not arrived and wakes up when a frame from outside the on-board device 101 has been received via the communication ports 10H and 10L and the PN transceiver 13, that is, when the PN transceiver 13 has outputted a frame that satisfies a predetermined condition to the processor 11.

When the processor 11 has received a frame from the PN transceiver 13 and woken up, the processor 11 performs a predetermined process, such as controlling equipment mounted in the vehicle, based on the data included in that frame and, after completing the process, transitions back into the sleep state.

### Details of Normal Transceiver Connection State

As depicted in FIG. 2, on determining that the state of the on-board device 101 satisfies a predetermined condition in a loopback test described later, the processor 11 outputs a control signal to the first switching unit 14 and the second switching unit 15 so that the on-board device 101 enters the normal transceiver connection state.

Examples of cases where the connection state of the on-board device 101 satisfies a predetermined condition include a case where there is a problem at the PN transceiver 13, in the software of the processor 11 that processes a frame from the PN transceiver 13, and the like.

After a predetermined time T1 has elapsed from the timing at which a control signal was outputted to the first switching unit 14 and the second switching unit 15 for example, the processor 11 checks, by checking the states of the first switching unit 14 and the second switching unit 15, whether the switching to the normal transceiver connection state has been completed. On confirming that the switching to the normal transceiver connection state has been completed, the processor 11 transitions to the sleep state.

In the normal transceiver connection state, a frame transmitted from outside the on-board device 101 into the on-board device 101 arrives at the normal transceiver 12 via the communication ports 10H and 10L. On receiving the frame, the normal transceiver 12 outputs the frame to the processor 11 as described earlier.

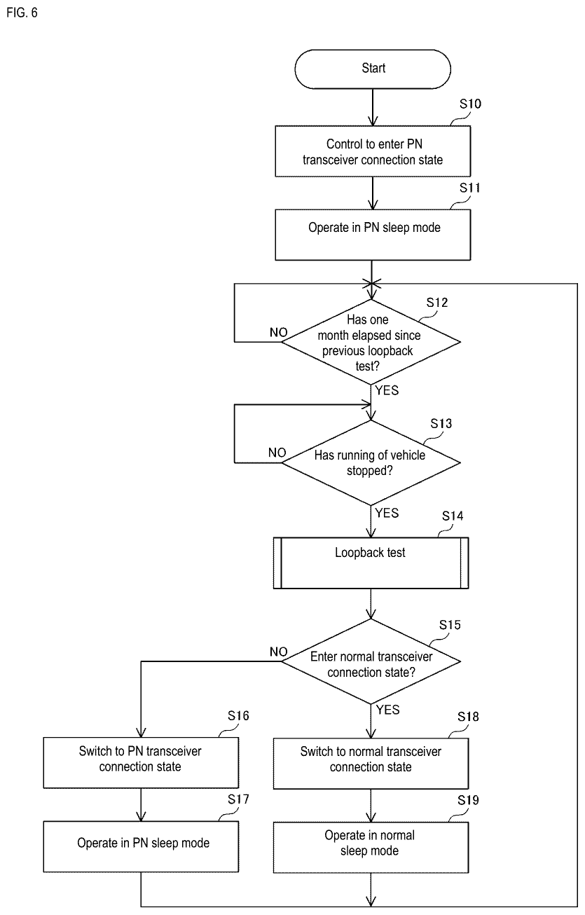

FIG. 5 is a diagram useful in explaining the operation of the processor when the on-board device according to the embodiment of the present disclosure is in the normal transceiver connection state. As depicted in FIG. 5, when the on-board device 101 is in the normal transceiver connection state, the processor 11 operates in a mode where the processor 11 intermittently wakes up (hereinafter referred to as “normal sleep mode”).

As one example, the processor 11 wakes up with a predetermined cycle, and transitions back to the sleep state when a predetermined time T2 has elapsed from waking up. The length of the predetermined time T2 for which the processor 11 is awake is shorter than the wake-up cycle of the processor 11.

If the processor 11 receives a frame from the outside of the on-board device 101 via the communication ports 10H and 10L and the normal transceiver 12 in a state where the processor 11 is awake, the processor 11 refers to the ID or the like of the frame and determines whether the frame satisfies a predetermined condition. If the frame does not satisfy the predetermined condition, the processor 11 discards the frame, for example.

On the other hand, if the frame satisfies the predetermined condition, the processor 11 performs predetermined processing, such as controlling equipment mounted in the vehicle, based on data included in the frame, for example. The processor 11 then transitions back to the sleep state at whichever of the timing at which the processing is completed and the timing at which the predetermined time T2 has elapsed from the wake-up timing of the processor 11 is later.

### Details of Loopback Connection State

As depicted in FIG. 3, the processor 11 performs a loopback test periodically or irregularly. As a detailed example, once a month, for example, in a state where the vehicle in which the on-board device 101 is mounted has stopped running, the processor 11 outputs a control signal to the first switching unit 14 and the second switching unit 15 so that the on-board device 101 enters the loopback connection state. Example states where the vehicle has stopped running include a state where the vehicle is parked and a state where the vehicle has temporarily stopped.

As one example, after a predetermined time T3 has elapsed from the timing at which the control signal was outputted to the first switching unit 14 and the second switching unit 15, the processor 11 checks, by checking the states of the first switching unit 14 and the second switching unit 15, whether the switching to the loopback connection state has been completed.

On confirming that the switching to the loopback connection state has been completed, the processor 11 performs a loopback test in which frames are transmitted and received between the normal transceiver 12 and the PN transceiver 13.

That is, in the loopback test, as one example, the processor 11 outputs a test frame which satisfies the predetermined condition described above to the normal transceiver 12 and performs a first test that checks whether this frame can be received from the PN transceiver 13. The processor 11 may also output a test frame to the PN transceiver 13 and perform a second test that checks whether this frame can be received from the normal transceiver 12.

Note that the test frame outputted in the second test may be a frame that satisfies a predetermined condition, or may be a frame that does not satisfy a predetermined condition.

As one example, if the test frames have been received as normal in both the first test and the second test, the processor 11 determines that the PN transceiver 13, the software of the processor 11 that processes frames from the PN transceiver 13, and the like are normal. In this case, the processor 11 controls the first switching unit 14 and the second switching unit 15 so that the on-board device 101 transitions from the loopback connection state to the PN transceiver connection state.

On the other hand, if for example the processor 11 is unable to normally receive the test frame in at least one of the first test and the second test, the processor 11 determines that there is a problem at the PN transceiver 13, the software of the processor 11 that processes frames from the PN transceiver 13, or the like. In this case, the processor 11 assumes that the state of the on-board device 101 satisfies a predetermined condition and controls the first switching unit 14 and the second switching unit 15 so that the connection state of the on-board device 101 transitions from the loopback connection state to the normal transceiver connection state.

Note that the processor 11 is not limited to a configuration that periodically performs a loopback test. As one example, a configuration may be used where the processor 11 performs a loopback test when the on-board device 101 is in the PN transceiver connection state and an error, such as an inability to normally receive a frame from the outside, has been detected or when for example an instruction to perform a loopback test has been received via an external network and an external communication device, not illustrated, from a management center of the vehicle.

The processor 11 is not limited to a configuration that performs both the first test and the second test, and may be configured to not perform the second test, for example.

The processor 11 may also be configured to not perform a loopback test. As examples, the processor 11 may control the first switching unit 14 to place the connection state of the on-board device 101 in the normal transceiver connection state without performing a loopback test in situations such as when the on-board device 101 is in the PN transceiver connection state and an error, such as an inability to normally receive a frame from the outside, has been detected or when it has become necessary to place the on-board device 101 in the normal transceiver connection state in keeping with the processing of a frame from the outside. By doing so, the connection state of the on-board device 101 can be appropriately switched according to the states of the first switching unit 14 and the second switching unit 15 and also factors such as the processing content of the on-board device 101. In this case, the on-board device 101 does not need to include the second switching unit 15.

### Flow of Operations

Next, the flow of operations of the on-board device 101 will be described with reference to the drawings.

The on-board device 101 is provided with a computer including a memory. An arithmetic processing unit, such as a CPU, in the computer reads a program, which includes some or all of the steps in the following flowchart, from the memory and executes the program. This program of the on-board device 101 can be installed from outside. The program of the on-board device 101 is distributed via a communication line or by being recorded on a recording medium.

### Overall Flow

FIG. 6 is a flowchart that defines one example operation procedure for switching the connection state of the on-board device according to an embodiment of the present disclosure. Here, it is assumed that the cycle with which the on-board device 101 performs loopback tests is one month.

As depicted in FIG. 6, when the on-board device 101 starts operating, the processor 11 first controls the first switching unit 14 and the second switching unit so that the on-board device 101 enters the PN transceiver connection state (step S10) and operates in the PN sleep mode (step S11).

Next, the processor 11 checks whether one month has elapsed since the previous loopback test was performed (step S12).

If one month has not elapsed since the previous loopback test was performed (“NO” in step S12), the processor 11 keeps the on-board device 101 in the PN transceiver connection state and continues operating in the PN sleep mode.

On the other hand, if one month has elapsed since the timing at which the previous loopback test was performed (“YES” in step S11), the processor 11 checks whether the vehicle in which the on-board device 101 is installed has stopped running (step S13).

If the vehicle has not stopped running (“NO” in step S13), the processor 11 keeps the on-board device 101 in the PN transceiver connection state and continues operating in the PN sleep mode while standing by until the vehicle stops running. On the other hand, if the vehicle has stopped running (“YES” in step S13), the processor 11 performs a loopback test (step S14).

Next, the processor 11 determines whether the connection state of the on-board device 101 should be set to the normal transceiver connection state based on the result of the loopback test (step S15).

As one example, assume that the processor 11 has determined in a loopback test that the PN transceiver 13, the software of the processor 11 that processes frames from the PN transceiver 13, and the like are normal. In this case, the processor 11 determines that the connection state of the on-board device 101 should be set to the PN transceiver connection state (“NO” in step S15).

After this, the processor 11 controls the first switching unit 14 and the second switching unit 15 so that the connection state of the on-board device 101 is switched from the loopback connection state to the PN transceiver connection state (step S16) and operates in the PN sleep mode (step S17). The processor 11 then performs the operations again starting from step S12.

As a different example, assume that the processor 11 has determined in a loopback test that there is a problem with the PN transceiver 13, the software of the processor 11 that processes frames from the PN transceiver 13, or the like. In this case, since the state of the on-board device 101 satisfies a predetermined condition, the processor 11 determines that the connection state of the on-board device 101 should be set to the normal transceiver connection state (“YES” in step S15).

The processor 11 then controls the first switching unit 14 and the second switching unit 15 so that the connection state of the on-board device 101 is switched from the loopback connection state to the normal transceiver connection state (step S18), and operates in the normal sleep mode (step S19). After this, the processor 11 performs the operations again starting from step S12.

Note that in the loopback test, the processor 11 is not limited to detecting problems with the PN transceiver 13, the software of the processor 11 that processes frames from the PN transceiver 13, or the like, and as one example may switch the connection state of the on-board device 101 to the normal transceiver connection state in keeping with a notification from a management center.

As one example, as described later, the processor 11 notifies the management center of the results of the first test and the second test in a loopback test. In this case, as one example, the management center side determines whether there is a problem with the PN transceiver 13 or the like of an on-board device 101 based on the results of a loopback test performed by that on-board device 101. On determining that there is a problem at the PN transceiver 13 or the like, the management center transmits a notification to enter the normal transceiver connection state to that on-board device 101.

When a notification that the on-board device 101 should enter the normal transceiver connection state has been received from the management center, the processor 11 in the on-board device 101 switches the connection state of the on-board device 101 to the normal transceiver connection state.

### Flow of Loopback Test

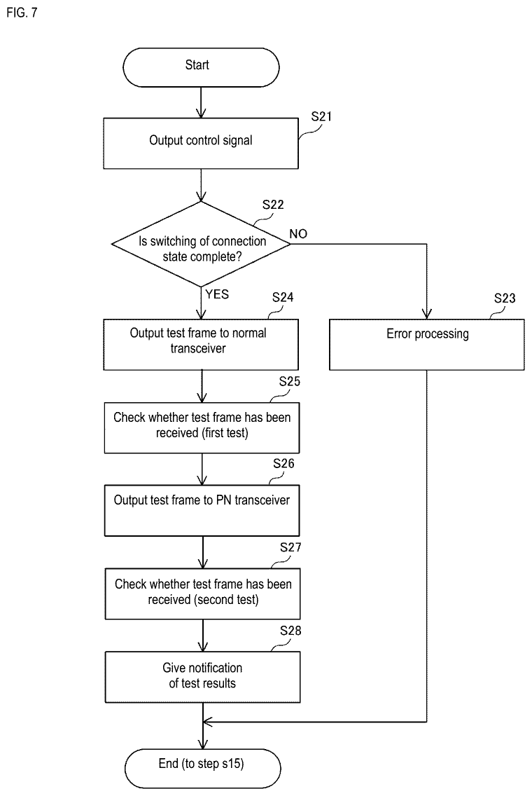

FIG. 7 is a flowchart defining an example operation procedure of a loopback test of an on-board device according to an embodiment of the present disclosure. FIG. 7 depicts the details of step S14 in FIG. 6.

As depicted in FIG. 7, the processor 11 first outputs a control signal to the first switching unit 14 and the second switching unit 15 so that the connection state of the on-board device 101 is switched from the PN transceiver connection state or the normal transceiver connection state to the loopback connection state (step S21).

Next, as one example, the processor 11 checks, by checking the states of the first switching unit 14 and the second switching unit 15, whether the switching to the loopback connection state has been completed when a predetermined time T3 has elapsed from the timing at which the control signal was outputted to the first switching unit 14 and the second switching unit 15 (step S22).

If the switching to the loopback connection state has not been completed (“NO” in step S22), the processor 11 performs error processing, such as providing a notification (step S23).

In this case, in step S15 depicted in FIG. 6, if the connection state of the on-board device 101 before switching to the loopback connection state (step S21) is the PN transceiver connection state, the processor 11 determines that the on-board device 101 should be placed in the PN transceiver connection state (“NO” in step S15) and then performs the operations in step S16 and step S17.

In step S15, if the connection state of the on-board device 101 before switching to the loopback connection state (step S21) is the normal transceiver connection state, the processor 11 determines that the on-board device 101 should be placed in the normal transceiver connection state (“YES” in step S15), and then performs the operations in step S18 and step S19.

On the other hand, in step S22, when switching to the loopback connection state has been completed (“YES” in step S22), the processor 11 outputs a test frame which satisfies a predetermined condition to the normal transceiver 12 (step S24) and performs a first test that checks whether the frame has been received from the PN transceiver 13 (step S25).

Next, the processor 11 outputs another test frame to the PN transceiver 13 (step S26) and performs a second test that checks whether the frame has been received from the normal transceiver 12 (step S27).

Next, the processor 11 notifies the management center of the results of the first test and the second test for example via an external communication apparatus and an external network (step S28).

Note that between step S27 and step S28, the processor 11 may output a test frame, which satisfies a predetermined condition, to the normal transceiver 12 (step S24) and perform a first test to check whether the frame has been received from the PN transceiver 13 (step S25).

### Modifications

The processor 11 is not limited to a configuration where, when the on-board device 101 is in the PN transceiver connection state, the processor 11 operates in the PN sleep mode and therefore remains in the sleep state until a frame is received from the PN transceiver 13. The processor 11 may instead be configured to operate in a mode where the processor 11 intermittently wakes up.

That is, when the on-board device 101 is in either of the PN transceiver connection state and the normal transceiver connection state, the processor 11 may operate in a mode in which the processor 11 intermittently wakes up. In this case, as one example, the cycle at which the processor 11 wakes up is longer when the on-board device 101 is in the PN transceiver connection state longer than when the on-board device 101 is in the normal transceiver connection state. The on-board device 101 according to this modification is described in detail below.

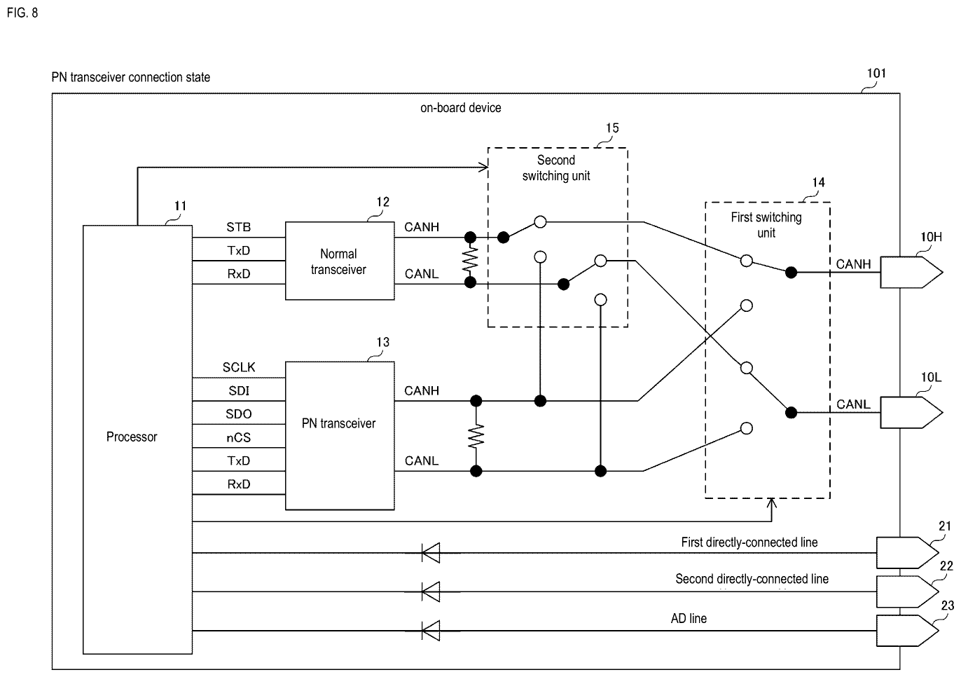

FIG. 8 depicts a configuration of an on-board device according to a modification to the embodiments of the present disclosure. In more detail, compared to the on-board device 101 depicted in FIG. 1, the on-board device 101 according to this modification further includes communication ports 21, 22, and 23. As examples, the communication ports 21, 22, and 23 are connectors or terminals of an integrated circuit.

The communication ports 21, 22, and 23 respectively correspond to a first directly-connected line and a second directly-connected line, which are communication lines used for transmitting a specific signal, and an AD line used for transmitting a signal indicating a measurement value or the like produced by a sensor mounted on the vehicle.

Here, assume that the transmission cycle into the on-board device 101 of frames inputted into the communication ports 10H and 10L is a first cycle St1 and the transmission cycle into the on-board device 101 of frames inputted into the communication port 21 is a second cycle St2. Assume also that the transmission cycle into the on-board device 101 of frames inputted into the communication port 22 is a third cycle St3, and the transmission cycle into the on-board device 101 of frames inputted into the communication port 24 is a fourth cycle St4.

It is assumed that the respective lengths of the first cycle St1, the second cycle St2, the third cycle St3, and the fourth cycle St4 satisfy a relationship where St1<St2<St3<St4.

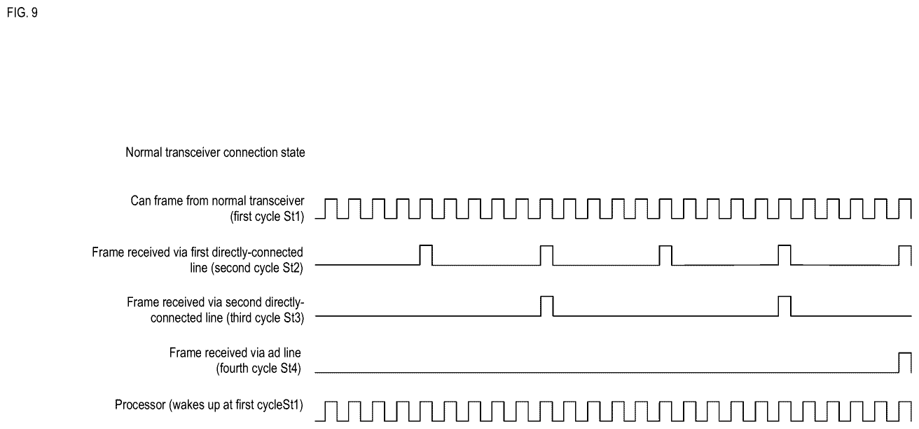

FIG. 9 is a timing chart indicating, for a case where the on-board device according to this modification to the embodiments of the present disclosure is in the normal transceiver connection state, the relationship between the timing at which the on-board device receives each frame and the timing at which the processor in the on-board device wakes up.

As depicted in FIG. 9, when the on-board device 101 is in the normal transceiver connection state, as one example, the processor 11 receives CAN frames transmitted from outside the on-board device 101 with the first cycle St1 via the communication ports 10H and 10L and the normal transceiver 12. For this reason, the processor 11 is set to operate in a mode where the processor 11 wakes up intermittently, as one example, with the first cycle St1. By doing so, the processor 11 can suppress power consumption and perform predetermined processing on the CAN frames from the communication ports 10H and 10L and each frame from the communication ports 21, 22, and 23.

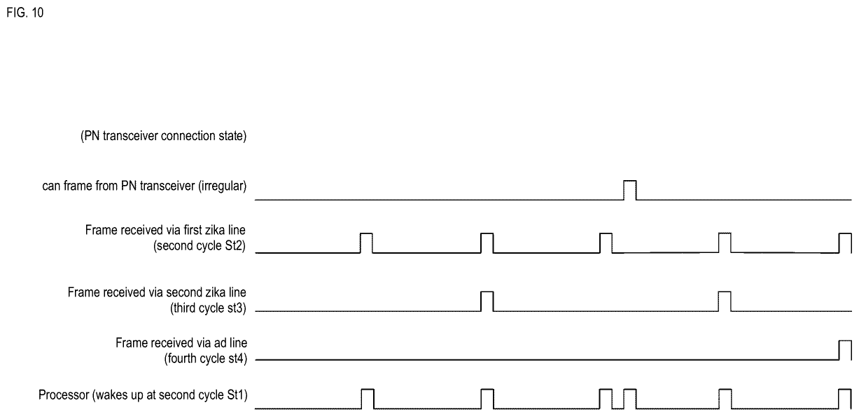

FIG. 10 is a timing chart indicating, for a case where the on-board device according to this modification to the embodiments of the present disclosure is in the PN transceiver connection state, the relationship between the timing at which the on-board device receives each frame and the timing at which the processor in the on-board device wakes up.

As depicted in FIG. 10, when the on-board device 101 is in the PN transceiver connection state, the processor 11 receives CAN frames that satisfy a predetermined condition from outside the on-board device 101 irregularly via the communication ports 10H and 10L and the PN transceiver 13.

On the other hand, as one example, the processor 11 receives frames transmitted from outside the on-board device 101 at the second cycle St2 via the communication port 21. For this reason, as one example, the processor 11 is set so as to operate in a sleep mode where the processor 11 intermittently wakes up with the second cycle St2 and operates in a mode where the processor 11 wakes up when a CAN frame that satisfies a predetermined condition has been received from the PN transceiver 13 during the sleep state. In this manner, the processor 11 can further reduce power consumption and perform predetermined processing on the CAN frames from the communication ports 10H and 10L that satisfy predetermined conditions and also on frames from the communication ports 21, 22, and 23.

All features of the embodiments disclosed here are exemplary and should not be regarded as limitations on the present disclosure. The scope of the present disclosure is indicated by the range of the patent claims, not the description given above, and is intended to include all changes within the meaning and scope of the patent claims and their equivalents.

The above description also includes the features given in the following appendix.

### APPENDIX 1

An on-board device mounted in a vehicle, including: a processor; a communication port; a first communication integrated circuit that is connected to the processor and that is configured to output a frame, which has been received via the communication port from outside the on-board device, to the processor; a second communication integrated circuit that is connected to the processor and is operable when a frame received via the communication port satisfies a predetermined condition, to output the received frame to the processor; and a first switching unit configured to switch the communication port between being connected to the first communication integrated circuit and being connected to the second communication integrated circuit, wherein the processor controls the first switching unit at a start of operation of the on-board device to electrically connect the second communication integrated circuit and the communication port, and the processor controls the first switching unit when a state of the on-board device satisfies a predetermined condition, to electrically connect the first communication integrated circuit and the communication port.

1. An on-board device mounted in a vehicle, comprising:
a processor;
a communication port;
a first communication integrated circuit that is connected to the processor and that is configured to output a frame, which has been received via the communication port from outside the on-board device, to the processor;
a second communication integrated circuit that is connected to the processor and is configured to, when a frame received via the communication port satisfies a predetermined condition, output the received frame to the processor; and
a first switching unit configured to switch the communication port between being connected to the first communication integrated circuit and being connected to the second communication integrated circuit.

2. The on-board device according to claim 1, further including;
a second switching unit that is connected between the first communication integrated circuit and the first switching unit,
wherein the second switching unit switches between a state where the first communication integrated circuit and the first switching unit are electrically connected and a state where the first communication integrated circuit and the second communication integrated circuit are electrically connected.

3. The on-board device according to claim 2, wherein in a state where the first switching unit electrically connects the second switching unit and the communication port and the second switching unit electrically connects the first communication integrated circuit and the second communication integrated circuit, the processor performs a loopback test for transmitting and receiving a frame between the first communication integrated circuit and the second communication integrated circuit.

4. The on-board device according to claim 1,
wherein the first communication integrated circuit is a CAN (Controller Area Network) transceiver, and
the second communication integrated circuit is a CAN receiver, which is compatible with partial networking.

5. The on-board device according to claim 3, wherein the processor performs the loopback test in a state where the vehicle is stopped.

6. The on-board device according to claim 5, wherein the state where the vehicle is stopped is a state where the vehicle is parked.

7. The on-board device according to claim 3, wherein in the loopback test, the processor performs a first test, which checks whether reception of a frame which was outputted to the first communication integrated circuit is possible from the second communication integrated circuit, and a second test, which checks whether reception of a frame outputted to the second communication integrated circuit is possible from the first communication integrated circuit, and notifies an external apparatus provided outside the vehicle of a result of the first test and a result of the second test.

8. The on-board device according to claim 7, wherein when the processor has received an instruction based on the result of the first test and the result of the second test from the external apparatus after notifying the external apparatus of the result of the first test and the result of the second test, the processor controls the first switching unit to switch the communication port between being connected to the first communication integrated circuit and being connected to the second communication integrated circuit in accordance with the instruction.

9. The on-board device according to claim 1,
wherein the processor is capable of performing a sleep operation, and
the processor switches modes relating to the sleep operation in a first connection state where the first switching unit electrically connects the first communication integrated circuit and the communication port and in a second connection state where the first switching unit electrically connects the second communication integrated circuit and the communication port.

10. The on-board device according to claim 9, wherein in the first connection state, the processor operates in a mode where the processor intermittently wakes up, and in the second connection state, the processor operates in a mode where the processor wakes up when a frame from outside the on-board device has been received from the second communication integrated circuit.

11. The on-board device according to claim 9,
wherein the processor operates in a mode where the processor wakes up intermittently, and a cycle at which the processor wakes up in the second connection state is longer than a cycle at which the processor wakes up in the first connection state.

12. A connection switching method of an on-board device mounted in a vehicle,
wherein the on-board device includes:
a processor;
a communication port;
a first communication integrated circuit that is connected to the processor and that is configured to output a frame, which has been received via the communication port from outside the on-board device, to the processor;
a second communication integrated circuit that is connected to the processor and is configured to, when a frame received via the communication port satisfies a predetermined condition, output the received frame to the processor; and
a first switching unit configured to switch the communication port between being connected to the first communication integrated circuit and being connected to the second communication integrated circuit,
the connection switching method comprising:
a step of controlling the first switching unit to electrically connect the communication port and the second communication integrated circuit; and
a step of controlling the first switching unit to electrically connect, when a state of the on-board device satisfies a predetermined condition, the communication port and the first communication integrated circuit.

13. A connection switching program for use in an on-board device mounted in a vehicle,
wherein the on-board device includes:
a processor;
a communication port;
a first communication integrated circuit that is connected to the processor and that is configured to output a frame, which has been received via the communication port from outside the on-board device, to the processor;
a second communication integrated circuit that is connected to the processor and is configured to, when a frame received via the communication port satisfies a predetermined condition, output the received frame to the processor; and
a first switching unit configured to switch the communication port between being connected to the first communication integrated circuit and being connected to the second communication integrated circuit,
the connection switching program causing a computer to function as a control unit configured to control the first switching unit to electrically connect the communication port and the second communication integrated circuit and controls the first switching unit to electrically connect, when a state of the on-board device satisfies a predetermined condition, the communication port and the first communication integrated circuit.
